(19) United States
(12) Patent Application Publication
(10) Pub. No.: US 2017/0287061 A1
(43) Pub. Date: Oct. 5, 2017

(54) PRODUCT PAYMENT METHOD AND ELECTRONIC DEVICE FOR SUPPORTING THE SAME

(71) Applicant: Samsung Electronics Co., Ltd., Suwon-si (KR)

(72) Inventors: Ju Myoung Chae, Seoul (KR); In Jong Rhee, Seongnam-si (KR); Jung A. Park, Seoul (KR); Yoon Soo Bae, Gwacheon-si (KR); Ji Su Oh, Yongin-si (KR); Dong Ho Jang, Hwaseong-si (KR)

(21) Appl. No.: 15/476,824

(22) Filed: Mar. 31, 2017

(30) Foreign Application Priority Data
Mar. 31, 2016 (KR) 10-2016-0039743

(51) Int. Cl. G06Q 30/06; G06Q 20/32

(52) U.S. Cl. CPC G06Q 30/0643; G06Q 30/0623; G06Q 30/0633; G06Q 20/3272; G06Q 20/3276; G06Q 20/3278

(57) ABSTRACT

An electronic device is disclosed. The electronic device includes a memory, a display, and a processor configured to electrically connect with the memory and the display. The processor is configured to execute a payment application program for performing payment about a product, if receiving a first user input and display a user interface for searching for the product on at least part of a screen where the payment app is executed.

### CROSS-REFERENCE TO RELATED APPLICATION(S) AND CLAIM OF PRIORITY

This application claims the benefit under 35 U.S.C. §119(a) of a Korean patent application filed on Mar. 31, 2016 in the Korean Intellectual Property Office and assigned Serial number 10-2016-0039743, the entire disclosure of which is hereby incorporated by reference.

### TECHNICAL FIELD

The present disclosure relates to an electronic device for composing graphic data and a method thereof.

### BACKGROUND

An electronic device such as a smartphone or a tablet personal computer (PC) may perform a variety of functions such as a wireless data communication function, a video play function, and an Internet search function. Functions of the electronic device have become increasingly expanded. Recently, a payment function for mobile shopping using the electronic device or an offline payment function using short-range communication (e.g., magnetic secure transmission (MST) communication, or a near field communication (NFC) communication) have been added. For example, a user may verify product information using a shopping application program (hereinafter referred to as “shopping app”) and the like and may determine a payment mode. If the payment mode is determined, a payment app may be executed to proceed with payment. The payment app may be connected to a payment server, a card issuer server, or the like to request the payment server or the card issuer server to approve payment and may receive the payment result.

A product payment method using an electronic device according to the related art may be manually executed based on a user input or a request of another app without analyzing needs of the user to perform a simple payment function. In this case, it is essential to perform a process of searching for a product the user wants. If the product the user wants is found, a payment app should be separately executed to proceed with payment for the product.

### SUMMARY

To address the above-discussed deficiencies, it is a primary to provide at least the advantages described below.

In accordance with an aspect of the present disclosure, an electronic device is provided. The electronic device may include a memory, a display, and a processor configured to electrically connect with the memory and the display. The processor is configured to execute a payment application (app) for performing payment about a product, if receiving a first user input, display a user interface for searching for the product on at least part of a screen where the payment app is executed, collect a product identifier based on a second user input, if receiving the second user input on the user interface, display information about the product based on the product identifier, perform user authentication for the payment for the product, and request an external payment server to perform the payment and receive the payment result corresponding to the request.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an electronic device according to various embodiments;

FIGS. 2A and 2B are flowcharts illustrating a product payment method according to various embodiments;

FIG. 3 is a drawing illustrating an example of a screen of a payment application program (app), which displays information about a targeted product, according to various embodiments;

FIG. 4A is a flowchart illustrating a process of storing product information according to various embodiments;

FIG. 4B is a signal sequence diagram illustrating a process of storing product information in an internal memory of an electronic device according to various embodiments;

FIG. 5 is a drawing illustrating an example of a screen of recognizing a user input as a storage event for storing product information according to various embodiments;

FIG. 6 is a drawing illustrating an example of a screen for recognizing a sound input as a storage event for storing product information according to various embodiments;

FIG. 7A is a block diagram illustrating a process of providing product information based on a location of a user according to various embodiments;

FIG. 7B is a flowchart illustrating a process of providing product information by providing a separate user interface (UI) according to various embodiments;

FIG. 8A is a flowchart illustrating a process of providing an optimal payment means together with product information according to various embodiments;

FIG. 8B is a drawing illustrating an example of a screen which displays an optimal payment means and an example of stored product information according to various embodiments;

FIG. 9 is a signal sequence diagram illustrating a product payment process through a payment app according to various embodiments;

FIG. 10 is a block diagram illustrating a process if product information is not stored in an electronic device, according to various embodiments;

FIG. 11A is a flowchart illustrating a payment mode on a lock screen according to various embodiments;

FIG. 11B is a drawing illustrating an example of product payment in a lock screen state according to various embodiments;

FIG. 12 is a block diagram illustrating a configuration of an electronic device according to various embodiments;

FIG. 13 is a block diagram illustrating a configuration of a program module according to various embodiments; and

FIG. 14 is a block diagram illustrating a configuration of a payment system according to various embodiments.

Throughout the drawings, it should be noted that like reference numbers are used to depict the same or similar elements, features, and structures.

### DETAILED DESCRIPTION

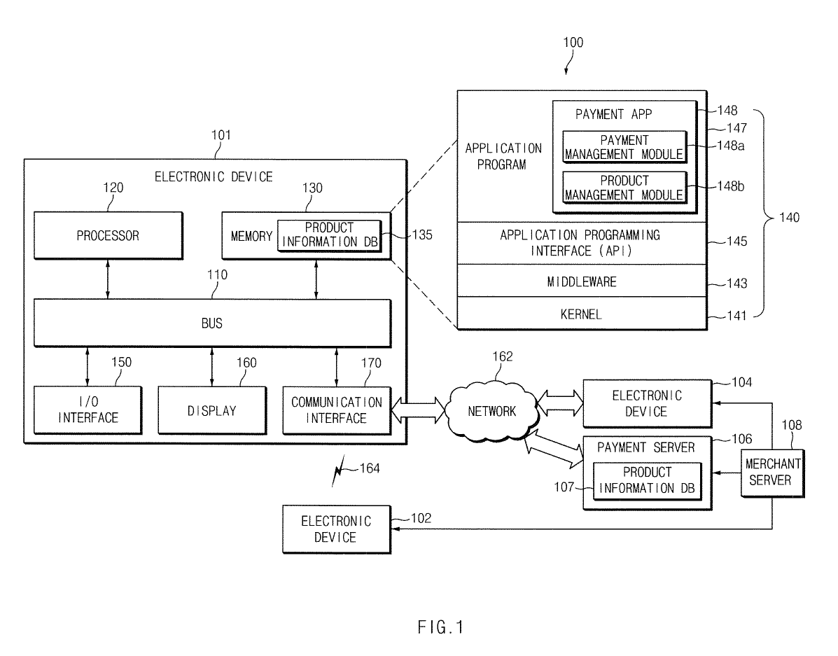

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. CPU, for example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital video disk (DVD) player, an audio, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller's machine (ATM) of a financial company, a point of sales (POS) of a store, or an internet of things (for example, a bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device according to some embodiments of the present disclosure may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

FIG. 1 is a block diagram illustrating a configuration of an electronic device according to various embodiments.

Referring to FIG. 1, an electronic device 101 in a network environment 100 according to various embodiments is shown.

The electronic device 101 in various embodiments may connect with an external device (e.g., a first external electronic device 102, a second external electronic device 104, or a payment server 106) over a network 162 or short-range communication 164. The electronic device 101 may include a bus 110, a processor 120, a memory 130, an input/output (I/O) interface 150, a display 160, and a communication interface 170. In various embodiments, at least one of the components may be omitted from the electronic device 101, or another component may be further included in the electronic device 101.

The bus 110 may include a circuit for connecting the above-mentioned elements 110 to 170 to each other and transferring communications (e.g., control messages and/or data) among the above-mentioned elements.

The processor 120 may include at least one of a central processing unit (CPU), an application processor (AP), or a communication processor (CP). The processor 120 may perform data processing or an operation related to communication and/or control of at least one of the other elements of the electronic device 101.

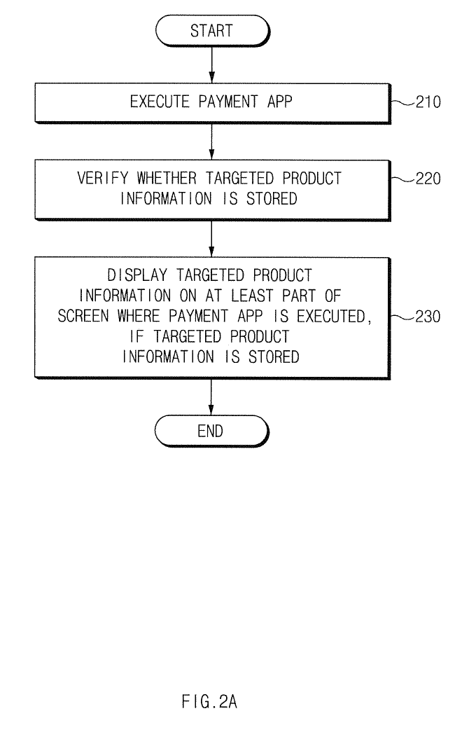

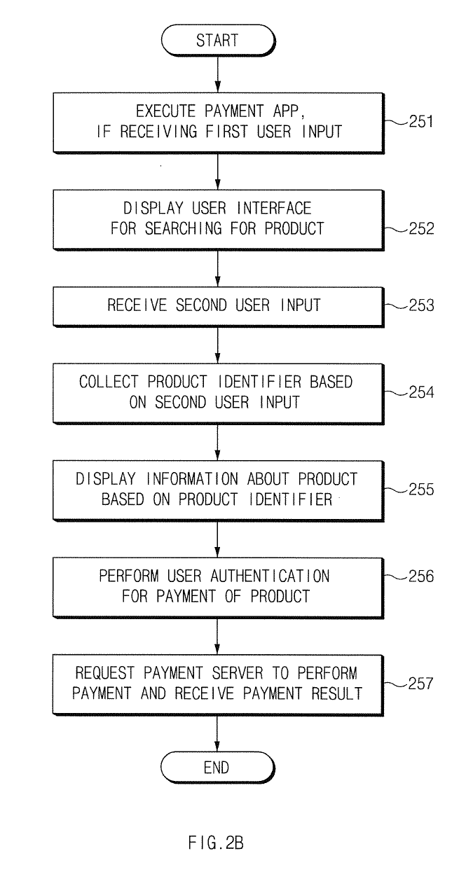

According to various embodiments, the processor 120 may display product information stored in a product information database (DB) 135 together on a screen associated with a payment app 148. The product information may be information about a product targeted at a user who uses the electronic device 101. The processor 120 may display information, about a product in which the user has interest currently or a product with a high possibility that he or she will purchase the product, on a screen where the payment app 148 is executed. If the payment app 148 is executed, information about a product targeted at the user may be automatically displayed. The user may simply proceed with payment for the product without a separate process of searching for the product. Additional information about a method for displaying information about a targeted product and a method for paying for the product may be provided with reference to FIGS. 2A to 11B.

The memory 130 may include a volatile memory and/or a nonvolatile memory. The memory 130 may store instructions or data related to at least one of the other elements of the electronic device 101. According to an embodiment of the present disclosure, the memory 130 may store software and/or a program 140. The program 140 may include, for example, a kernel 141, a middleware 143, an application programming interface (API) 145, and/or an application program (or an application) 147. At least a portion of the kernel 141, the middleware 143, or the API 145 may be referred to as an operating system (OS).

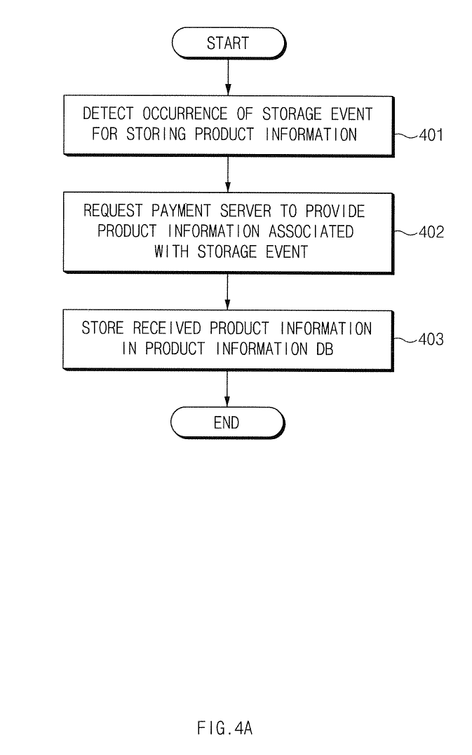

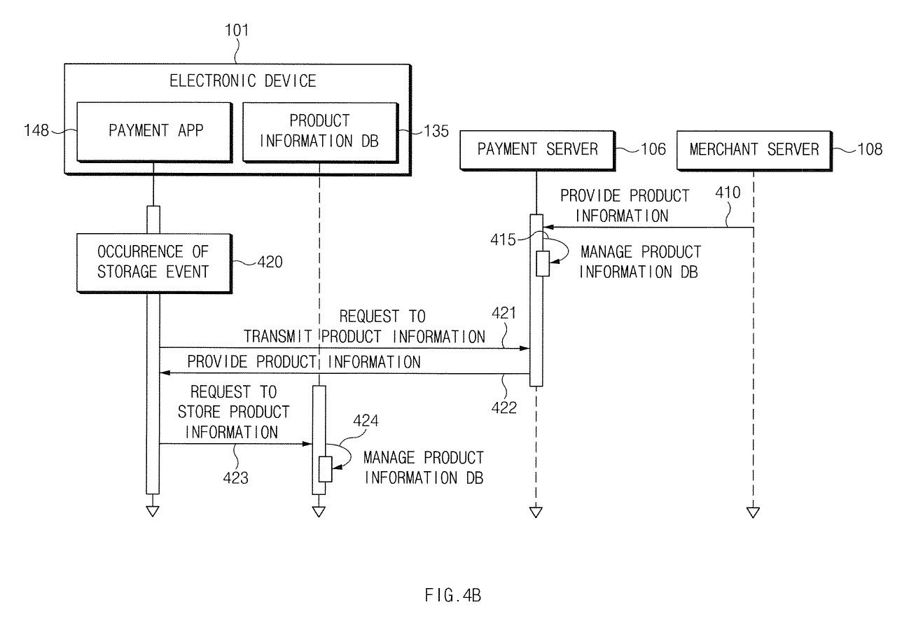

According to various embodiments, the memory 130 may include the product information DB 135. The product information DB 135 may be updated based on a DB included in the external device (e.g., the payment server 106) according to a specified condition. If an event associated with product information is generated, for example, if a specified input of the user occurs, if a sound around the electronic device 101 is input, or if a wireless communication signal is received, the product information DB 135 may be updated. Additional information about a method for storing product information in the product information DB 135 or a method for updating product information may be provided with reference to FIGS. 4A to 6.

The kernel 141 may control or manage system resources (e.g., the bus 110, the processor 120, the memory 130, or the like) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 101 in order to control or manage the system resources.

The middleware 143 may serve as an intermediary so that the API 145 or the application program 147 communicates and exchanges data with the kernel 141.

Furthermore, the middleware 143 may handle one or more task requests received from the application program 147 according to a priority order. For example, the middleware 143 may assign at least one application program 147 a priority for using the system resources (e.g., the bus 110, the processor 120, the memory 130, or the like) of the electronic device 101. For example, the middleware 143 may handle the one or more task requests according to the priority assigned to the at least one application, thereby performing scheduling or load balancing with respect to the one or more task requests.

The API 145, which is an interface for allowing the application 147 to control a function provided by the kernel 141 or the middleware 143, may include, for example, at least one interface or function (e.g., instructions) for file control, window control, image processing, character control, or the like.

According to various embodiments, an application program 147 may include the payment app 148. The payment app 148 may proceed with payment for a product via the payment server 106. In various embodiments, the payment app 148 may output information about a product targeted at the user together. The user may verify the product information may immediately proceed with payment for the product using the payment app 148.

According to various embodiments, the payment app 148 may include a payment management module 148a and a product management module 148b. The payment management module 148a may perform a function or operation associated with payment for a product. The product management module 148b may read product information stored in the product information DB 135 or may store and manage product information received from the payment server 106 in the product information DB 135.

The input/output interface 150 may serve to transfer an instruction or data input from a user or another external device to (an)other element(s) of the electronic device 101. Furthermore, the input/output interface 150 may output instructions or data received from (an)other element(s) of the electronic device 101 to the user or another external device.

The display 160 may include, for example, a liquid crystal display (LCD), a light-emitting diode (LED) display, an organic light-emitting diode (OLED) display, a microelectromechanical systems (MEMS) display, or an electronic paper display. The display 160 may present various content (e.g., a text, an image, a video, an icon, a symbol, or the like) to the user. The display 160 may include a touch screen, and may receive a touch, gesture, proximity or hovering input from an electronic pen or a part of a body of the user.

The communication interface 170 may set communications between the electronic device 101 and an external device (e.g., a first external electronic device 102, a second external electronic device 104, or a server 106). For example, the communication interface 170 may be connected to a network 162 via wireless communications or wired communications so as to communicate with the external device (e.g., the second external electronic device 104 or the server 106).

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 164. The short-range communications may include at least one of wireless fidelity (Wi-H), Bluetooth, near field communication (NFC), magnetic stripe transmission (MST), or GNSS.

The MST may generate pulses according to transmission data and the pulses may generate electromagnetic signals. The electronic device 101 may transmit the electromagnetic signals to a reader device such as a POS (point of sales) device. The POS device may detect the magnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 832 (RS-232), plain old telephone service (POTS), or the like. The network 162 may include at least one of telecommunications networks, for example, a computer network (e.g., local area network (LAN) or wide area network (WAN)), the Internet, or a telephone network.

According to various embodiments, the communication interface 170 may be used to detect an event of storing product information through wireless communication with the external device. For example, the communication interface 170 may detect a Bluetooth low energy (BLE) signal, a beacon signal, and the like and may transmit the detected information to the processor 120.

The types of the first external electronic device 102 and the second external electronic device 104 may be the same as or different from the type of the electronic device 101. According to an embodiment of the present disclosure, the server 106 may include a group of one or more servers. A portion or all of operations performed in the electronic device 101 may be performed in one or more other electronic devices (e.g., the first external electronic device 102, the second external electronic device 104, or the server 106). When the electronic device 101 should perform a certain function or service automatically or in response to a request, the electronic device 101 may request at least a portion of functions related to the function or service from another device (e.g., the first external electronic device 102, the second external electronic device 104, or the server 106) instead of or in addition to performing the function or service for itself. The other electronic device (e.g., the first electronic external device 102, the second external electronic device 104, or the server 106) may perform the requested function or additional function, and may transfer a result of the performance to the electronic device 101. The electronic device 101 may use a received result itself or additionally process the received result to provide the requested function or service. To this end, for example, a cloud computing technology, a distributed computing technology, or a client-server computing technology may be used.

According to various embodiments, each of the first and second external electronic devices 102 and 104 may be a source device which provides product information. The source device may receive product information from a merchant server 108. According to various embodiments, the source device may be a sound or image output device (e.g., a television (TV), a digital signage, or the like) or a wireless communication device (e.g., a beacon device or the like).

According to various embodiments, the payment server 106 may include a product information DB 107. The product information DB 107 may store product information provided from a merchant server (e.g., a server of Amazon, eBay, Auction, G-market, or the like) connected with the payment server 106. The product information may include a product identifier, a product type, a product image, a product price, an age group of a target customer, a target gender, benefit information, store information, and the like.

In FIG. 1, an embodiment is exemplified as the product information DB 107 is included in the payment server 106. However, embodiments are not limited thereto. For example, the product information DB 107 may be stored and managed by a separate product server (not shown). The product server may store product information provided from the merchant server 108. The product server may provide the stored product information based on a request of the payment server 106 or the electronic device 101. Hereinafter, a description will be given of an example in which the product information DB 107 is included in the payment server 106.

FIG. 2A is a flowchart illustrating a product payment method according to an embodiment.

Referring to FIG. 2A, in operation 210, a processor 120 of FIG. 1 may execute a payment app 148 of FIG. 1. The payment app 148 may be executed by a user input (e.g., execution of an icon, a fingerprint input, a swipe input, a multi-touch input, an input using a physical button, or the like) or may be automatically executed (e.g., a call of another app). In various embodiments, if a touch input of a specified direction occurs on a physical button (e.g., a home button), the payment app 148 may be executed.

In various embodiments, the payment app 148 may be executed by a touch input which occurs in a specified direction (e.g., a direction from an edge of a display 160 of FIG. 1 to the center) from a first point (e.g., an edge) of the display 160.

In various embodiments, operations 210 to 230 may be applied if a user input for displaying information about a payment means (e.g., a credit card) on a screen where the payment app 148 is executed is generated and may fail to be applied if a user input for not displaying the information about the payment means is generated.

The payment app 148 may store credit card information of the user and may output a user interface (UI) for entering a password (e.g., a personal identification number (PIN)) and biometric information (e.g., fingerprint information), and the like for proceeding with payment from the user. In various embodiments, the payment app 148 may transmit and receive information (e.g., encrypted credit card information, encrypted password information, and the like), used for proceeding with payment, with a payment server 106 of FIG. 1 through wireless communication.

In operation 220, the processor 120 may verify whether information about a product targeted at the user is stored in a product information DB 135 of FIG. 1. The targeted product information may be information about a product in which the user has interest or a product with a high probability that he or she will purchase the product. The targeted product information may include a product identifier, a product type, a product image, a good price, an age group of a target customer, a target gender, benefit information, store information, and the like.

For example, the user may verify a code output on a screen of a TV while viewing a home shopping program on the screen of the TV. If the user enters the code in a screen of the electronic device 101, the processor 120 may request the payment server 106 by using the code as a product identifier. The processor 120 may store product information received from the payment server 106 as a targeted product information in the product information DB 135 or may display the product information on a screen where the payment app 148 is executed.

For another example, if the user enters an offline store, the processor 120 may recognize a product identifier using a wireless communication signal such as a BLE signal, a beacon signal, or the like. The processor 120 may request the payment server 106 to transmit product information using the product identifier. The processor 120 may store product information received from the payment server 106 as targeted product information in the product information DB 135.

According to various embodiments, the processor 120 may receive information, about a product in which the user has interest or a product with a high possibility that he or she will purchase the product, from the payment server 106 based on the user input, a sound around the user (or the electronic device 101), and a wireless communication signal. The processor 120 may update the product information DB 135 based on a specified condition (e.g., upon booting, when the payment app 148 is executed, or when a wireless communication signal is received) or at intervals of a specified time.

According to various embodiments, if targeted product information is not stored, the processor 120 may perform a general operation for product payment (e.g., display credit card information, provide a UI for selecting a credit card, provide a UI for receiving a payment password, and the like).

In operation 230, if the targeted product information is stored, the processor 120 may display the targeted product information on at least part of a screen where the payment app 148 is executed. The user may verify the targeted product information displayed on the payment app 148 and may immediately proceed with payment for the product using the payment app 148 which is being executed.

FIG. 2B is a flowchart illustrating a product payment method according to an embodiment.

Referring to FIG. 2B, in operation 251, if receiving a first user input, a processor 120 of FIG. 1 may execute a payment app 148 of FIG. 1, which may pay for a product. For example, the first user input may include at least one of a touch input, a swipe input, a force touch input, a multi-touch input, and a gesture input.

According to various embodiments, if receiving the first user input in at least one of a screen-off state, a lock screen output state, and a home screen output state, the processor 120 may execute the payment app 148.

In operation 252, the processor 120 may display a UI for searching for a product on at least part of a screen where the payment app 148 is executed. The processor 120 may provide a UI for receiving at least one of a text input, an input using a camera of an electronic device 101 of FIG. 1, or an input using a microphone of the electronic device 101.

According to various embodiments, the processor 120 may display information about a payment means (e.g., a credit card) for payment and the UI on one screen.

In operation 253, the processor 120 may receive a second user input through the UI. For example, the second user input may include at least one of a text code input, a barcode input, a quick response (QR) code input, or a sound input.

In operation 254, the processor 120 may collect a product identifier based on the second user input.

In operation 255, the processor 120 may display information about the product based on the product identifier. The processor 120 may request the payment server 106 to transmit the information about the product.

According to various embodiments, the processor 120 may receive account information of the user, previously stored in the payment server 106, or may receive account information of the user from the merchant server 108 of a merchant who purchases a product and may use the received account information for a payment process.

In operation 256, the processor 120 may perform user authentication for payment for the product. The processor 120 may perform the user authentication through fingerprint authentication or pin-number authentication.

In operation 257, the processor 120 may request the payment server 106 to perform payment and may receive a payment result corresponding to the request.

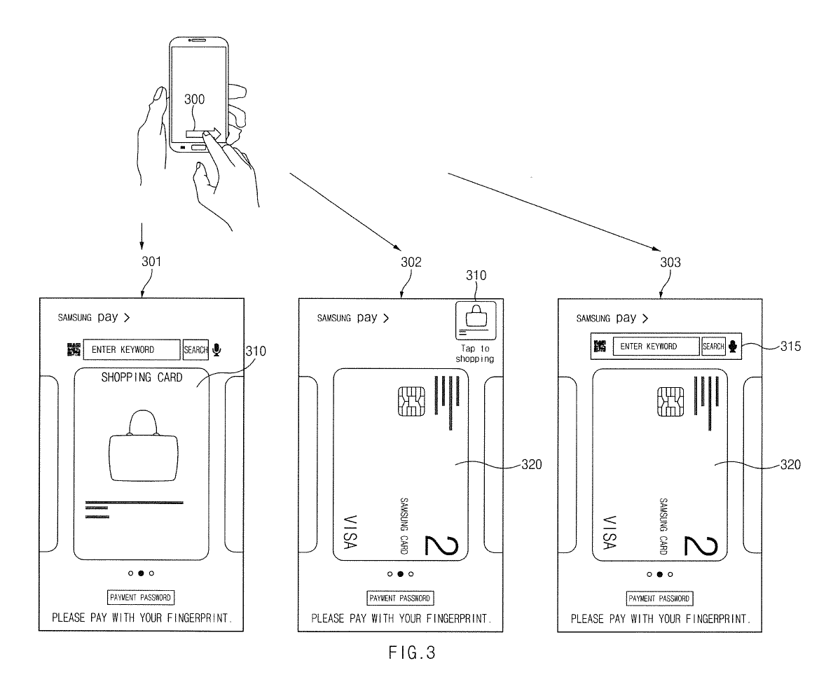

FIG. 3 is a drawing illustrating an example of a screen of a payment app, which displays information about a targeted product, according to various embodiments. FIG. 3 is, but is not limited to, an example.

Referring to FIG. 3, if a payment app 148 of FIG. 1 is executed, a processor 120 of FIG. 1 may display targeted product information 310 on at least part of a screen where the payment app 148 is executed. The targeted product information 310 may be output based on data stored in a product information DB 135 of a memory 130 in the electronic device 101.

According to various embodiments, the targeted product information 310 may be displayed on part of a screen where the payment app 148 is loaded or part of an initial screen where the payment app 148 is executed.

A payment app screen 301 may be configured relative to the targeted product information 310. The targeted product information 310 may be located on a central portion of the payment app screen 301, and other information (e.g., information about a payment progress method, app description, a product search, and the like) may be displayed on a region around the targeted product information 310.

According to various embodiments, if a user selects the targeted product information 310, additional information about a product may be provided. The additional information may be provided based on details stored in the product information DB 135 of the memory 130 or may be provided in an in-app browsing scheme through a hyperlink. According to various embodiments, the additional information may provide a UI associated with selecting an option (e.g., a color, a size, or the like) for the product.

According to various embodiments, if the user proceeds with payment (e.g., if a touch button is input or if fingerprint recognition is performed) in a state where the targeted product information 310 displayed, a UI for selecting a credit card and entering a password may be provided to the user. The user may immediately proceed with payment for the product.

A payment app screen 302 may be configured relative to credit card information 320. The targeted product information 310 may be located on a region around the credit card information 320. In this case, information about a product image or product description may be smaller on the payment app screen 301. If the user wants to verify additional information about the product, he or she touches the targeted product information 310 and may verify the additional information (e.g., a detailed image, product description, and the like). The user may verify the credit card information 320, may determine a credit card to proceed with payment, and may immediately proceed with the payment for the product.

According to various embodiments, if the separate targeted product information 310 is not stored in a memory 130 of FIG. 1, a general payment progress screen may be displayed or product information recommended to the user may be displayed.

According to various embodiments, if a plurality of targeted product information 310 (or if there is a plurality of options for selecting one product), a list of products may be output on a screen where the payment app 148 is executed. The user may select one product in the list and may proceed with payment.

FIG. 4A is a flowchart illustrating a process of storing product information according to various embodiments.

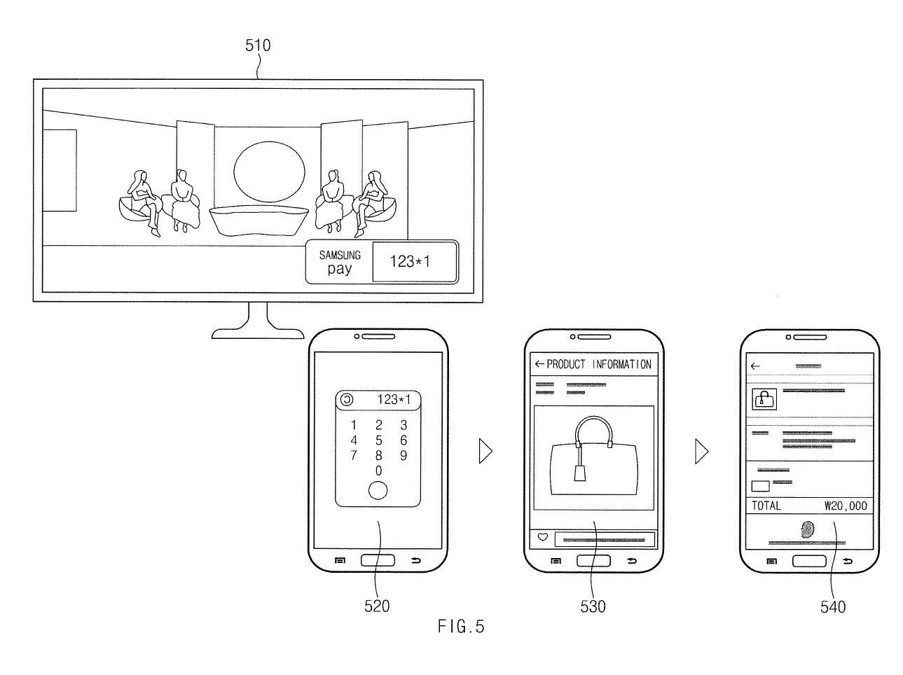

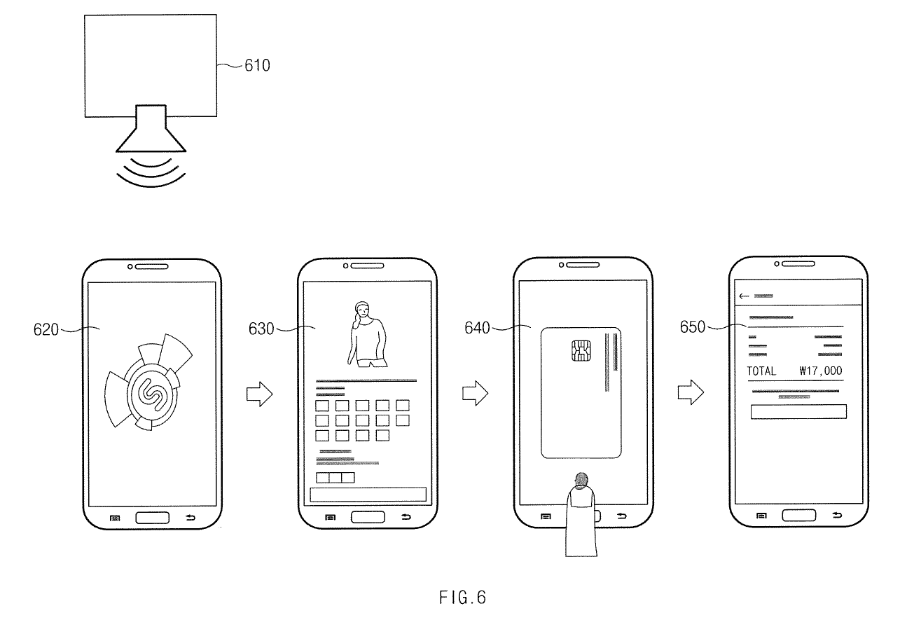

Referring to FIG. 4A, in operation 401, a processor 120 of FIG. 1 may detect occurrence of a storage event for storing product information. The storage event may be an event to start for an electronic device 101 of FIG. 1 to receive and store product information from a payment server 106 of FIG. 1. Also, the storage event may be an event for collecting information about a product in which a user has interest or a product with a high probability that he or she will purchase the product. For example, the storage event may a code input of the user, reception of a wireless communication signal, a sound input via a microphone of the electronic device 101, an image input via camera of the electronic device 101, or the like. Additional information about the storage event may be provided with reference to FIGS. 5 and 6.

In various embodiments, the processor 120 may parse information received through the storage event and may extract a product identifier such as a product title or a product code from the parsed information. For example, the processor 120 may digitalize and separate a sound collected during a specified time via the microphone and may extract a product title portion. Hereinafter, a description will be given of an example in which the product identifier is extracted. However, embodiments are not limited thereto. For example, the processor 120 may parse information received by the storage event. If a condition such as a product type, an age group for using a product, and gender for using the product is specified, the processor 120 may request the payment server 106 to transmit product information corresponding to the condition.

In operation 402, the processor 120 may request the payment server 106 to provide product information associated with the storage event. For example, the processor 120 may parse information received by the storage event, may extract product identifier such as a product title or a product code from the parsed information, and may transmit the extracted product information to the payment server 106. The payment server 106 may collect product information corresponding to the received product identifier among a plurality of product information stored in a product information DB 107 of FIG. 1. The product information stored in the product information DB 107 may transmitted and stored in advance from a merchant server 108 of FIG. 1. The payment server 106 may transmit the collected product information to the electronic device 101.

In various embodiments, the payment server 106 may be configured to transmit a simplified image such as a thumbnail image to the electronic device 101 and provide additional information of a product if a separate request is received.

In operation 403, the processor 120 may store product information received from the payment server 106 in a product information DB 135 in a memory 130 of FIG. 1. If a payment app 148 of FIG. 1 is executed, the stored product information may be automatically displayed on at least part of a screen where the payment app 148 is executed.

FIG. 4B is a signal sequence diagram illustrating a process of storing product information in an internal memory of an electronic device according to various embodiments.

Referring to FIG. 4B, in operation 410, a payment server 106 may receive product information from an merchant server 108. The merchant server 108 may include a plurality of merchant servers. The payment server 106 may receive product information (e.g., a product identifier, a product type, a product image, a product price, an age group of a target customer, a target gender, benefit information, store information, and the like) about a product sold by a merchant of each of the plurality of merchant servers.

In operation 415, the payment server 106 may store the product information received from the merchant server 108 in a product information DB 107 of FIG. 1. The payment server 106 may continuously manage the product information DB 107 to be synchronized with information stored in the merchant server 108.

In operation 420, a payment app 148 of an electronic device 101 may verify whether a storage event for storing product information is generated. For example, the storage event may be a code input of a user, reception of a beacon signal, a sound input via a microphone of the electronic device 101, an image input via a camera of the electronic device 101, or the like.

In operation 421, the payment app 148 may request the payment server 106 to transmit product information based on a product identifier such as a product title or a product code. The payment server 106 may extract product information about a product which has the same product identifier from the product information DB 107.

In operation 422, the payment server 106 may transmit the extracted product information to the electronic device 101.

In operation 423, the payment app 148 may request a product information DB 135 in the electronic device 101 to store the received product information.

In operation 424, the product information DB 135 may store the received product information and may continuously manage the stored product information. If the payment app 148 is executed by a user input or a call of another app, it may provide information about a product targeted at the user, based on data stored in the product information DB 135.

According to various embodiments, the processor 120 may determine (or select) targeted product information based on a specified condition (e.g., a weight value) among a plurality of product information stored in the product information DB 135.

In an embodiment, the processor 120 may calculate a weight value to product information in a different way based on a source which obtains the product information. For example, if the user directly enters a code, the processor 120 may determine that he or she explicitly has interest in a product and may assign a relatively high weight value to the product.

According to another embodiment, the processor 120 may determine targeted product information over an effective time of product information. For example, if obtaining product information through a TV home shopping program, the processor 120 may store broadcast time information of a product together with the product information. If the user views the product information within a time when the home shopping program is broadcast, the processor 120 may determine the product information as targeted product information.

In another embodiment, the processor 120 may determine targeted product information based on the number of times a product is exposed to the user and a time when a product is exposed to him or her. When there is the more number of times a product is exposed to the user and when a time when a product is exposed to him or her is longer, the product may be a product in which the user has high interest.

In another embodiment, the processor 120 may determine a product to be displayed, based on information about a product provided from a merchant. For example, the processor 120 may determine targeted product information using information, such as, an age, gender, and location of the user, and information such as promotion and sales of a product.

In another embodiment, the processor 120 may perform big data processing of response information and the like of the user about a displayed product and may more accurately determine and display a product the user wants to purchase.

FIG. 5 is a drawing illustrating an example of a screen of recognizing a user input as a storage event for storing product information according to various embodiments. FIG. 5 is, but is not limited to, an example.

Referring to FIG. 5, a user of an electronic device 101 of FIG. 1 may verify a code, such as a symbol, text, and/or a numeral, output on a screen of an external device 510 (e.g., a TV). A processor 120 of FIG. 1 may display a UI 520 for receiving the code. If the user enters the code, the processor 120 may request a payment server 106 of FIG. 1 to transmit product information by using the code as a product identifier. In FIG. 5, an embodiment is exemplified as the user enters a numeric code. However, embodiments are not limited thereto. For example, a QR code may be entered using a camera of the electronic device 101 or the code may be entered through barcode recognition.

The payment server 106 may collect product information corresponding to the code from a product information DB 107 of FIG. 1. The payment server 106 may transmit the collected product information to the electronic device 101.

The processor 120 may store the received product information as targeted product information in a product information DB 135 in the electronic device 101. If a payment app 148 of FIG. 1 is executed by a user input or a call of another app, targeted product information 530 may be output on a screen where the payment app 148 is executed.

The user may verify a product he or she wants to purchase through the targeted product information 530 and may immediately proceed with payment through the payment app 148 which is being executed. If the payment is completed, a payment completion screen 540 may be output.

FIG. 6 is a drawing illustrating an example of a screen for recognizing a sound input as a storage event for storing product information according to various embodiments.

Referring to FIG. 6, a variety of sounds may be generated around an electronic device 101 of FIG. 1 or a user of the electronic device 101. A processor 120 of FIG. 1 may start a process of storing product information using a sound collected via a sound acquisition circuit (e.g., a microphone) embedded in the electronic device 101.

On a screen 620, the processor 120 may collect a sound output from a device (e.g., a TV advertisement, TV home shopping, a kiosk, and the like) around the electronic device 101 using the microphone. The collected sound may be a sound of an audible or inaudible frequency band. In case of the sound of the inaudible frequency band, the user may fail to recognize the output of the sound and the electronic device 101 may start a process of storing product information using the sound.

The processor 120 may parse the sound collected via the microphone and may extract a product identifier (e.g., a product title, a product code, and the like) from the parsed sound. The processor 120 may request a payment server 106 of FIG. 1 to transmit product information based on the extracted product identifier. According to an embodiment, the task of parsing the sound may be performed using an analysis module independent of the processor 120. The analysis module may directly extract a product identifier from the collected sound, or may transmit data about the collected sound to an external device (e.g., an external server) (or may change the data to a specific format and may transmit the changed data to the external device) and may verify an advertisement, a broadcast program, and the like corresponding to the sound.

According to various embodiments, the analysis module may collect and analyze an image associated with a product (e.g., a real photo of the product, information about a QR code or a barcode, text indicating the product, or the like) using a camera of the electronic device 101. The analysis module may extract a product identifier from the image and may provide the extracted product identifier to the processor 120. The payment server 106 may collect product information corresponding to the product identifier from a product information DB 107 of FIG. 1. The payment server 106 may transmit the collected product information to the electronic device 101.

The processor 120 may store the received product information as targeted product information in a product information DB 135 in the electronic device 101. If a payment app 148 of FIG. 1 is executed by a user input or a call of another app, targeted product information 630 may be output on a screen where the payment app 148 is executed.

The user may verify a product he or she wants to purchase through the targeted product information 630 and may immediately proceed with payment through the payment app 148 which is being executed. An authentication screen 640 for user authentication may be output. If the payment is completed, a payment completion screen 650 may be output.

According to various embodiments, the processor 120 may store product information through a wireless communication signal. The processor 120 may extract product information from wireless communication signal (e.g., a BLE signal, a beacon signal, and the like) received via a communication interface 170 of FIG. 1 and may extract a product identifier (e.g., a product title, a product code, and the like) from the extracted product information. The processor 120 may request the payment server 106 to transmit product information based on the extracted product identifier.

According to various embodiments, if recognizing information about a program through a sound, the processor 120 may receive product placement (PPL) marketing information about the program using an external server and may store information about a product included in the PPL marketing information as targeted product information.

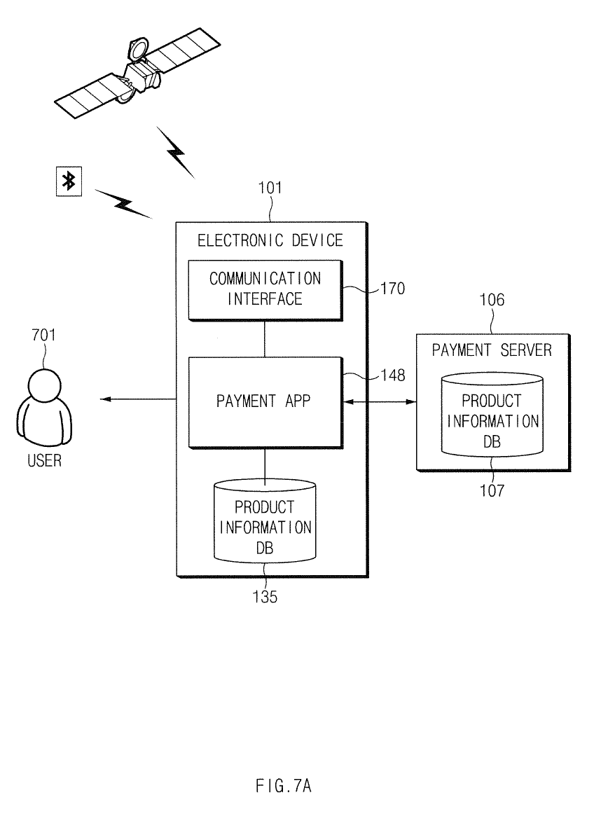

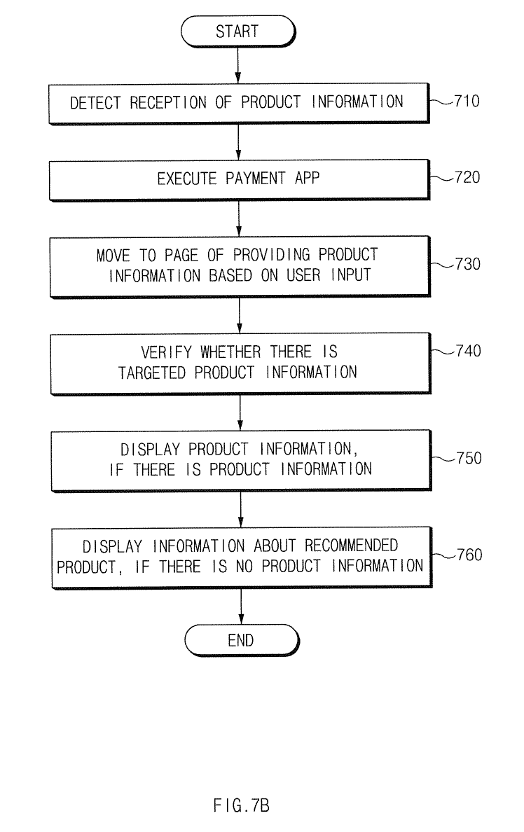

FIG. 7A is a block diagram illustrating a process of providing product information based on a location of a user according to various embodiments.

Referring to FIG. 7A, a processor 120 of FIG. 1 may determine a location of a user 701 (or an electronic device 101) based on a wireless communication signal received via a communication interface 170 and may provide product information according to the determined location to the user 701.

For example, if the user 701 enters an offline store, the processor 120 may determine that the user 701 enters the store, using a BLE signal or a GPS signal. If the user 701 enters or approaches the offline store while having the electronic device 101, the communication interface 170 may receive a short-range communication signal (e.g., a BLE signal, a beacon signal, a GPS signal, or the like). The processor 120 may receive store information over a channel established through the short-range communication signal. The processor 120 may transmit the store information to a payment server 106. The payment server 106 may search a product information DB 107 for product information based on the store information and may transmit the found product information to the electronic device 101.

According to various embodiments, the processor 120 may transmit identification information about the store the user 701 visits and an identifier of product information stored in a product information DB 135 to the payment server 106. The payment server 106 may store information about a product sold at each of offline stores in advance and may determine whether a product in which the user 701 has interest is sold at the store, based on the stored information.

The payment server 106 may provide information about a product matched with the product in which the user 701 has interest to the electronic device 101. The processor 120 may inform the user 701 of the information about the matched product using a pop-up window, product information displayed on the payment app 148, and the like.

For example, after the user 701 visits an offline store, the store may sell some of the products in which the user 701 has interest. The user 701 may verify information of the product (e.g., a price, a location where a product is located, and the like) and may directly verify the product.

In an embodiment, the user 701 may proceed with payment online using the payment app 148. If the user 701 completes payment about the product, information about the payment completion may be transmitted to a server of the offline store in real time. When the user 701 leaves the store, the user 701 may receive an automatically packaged product.

In another embodiment, the user 701 may proceed with payments offline using the payment app 148. If the user 701 executes the payment app 148, product information and payment information may be transmitted to the server of the offline store in real time. An MST payment device (e.g., a POS device) connected to the server of the offline store may wait for offline payment based on received product information and payment information. If the user 701 approaches the MST payment device (e.g., the POS device) within a specific distance, the MST payment device (e.g., the POS device) may proceed with payment by MST communication. The user 701 may reduce a waiting time for product payment and may simply proceed with payment.

FIG. 7B is a flowchart illustrating a process of providing product information by providing a separate user interface (UI) according to various embodiments.

In operation 710, a processor 120 of FIG. 1 may detect reception of product information. The product information may be received through a wireless communication signal or a sound generated around an electronic device 101 of FIG. 7A or a user of the electronic device 101.

In operation 720, the processor 120 may execute a payment app 148 of FIG. 7A. The payment app 148 may be executed by a user input (e.g., execution of an icon, a fingerprint input, or the like) or may be automatically executed (e.g., a call of another app or the like). The processor 120 may provide a specific UI for providing product information on a screen where the payment app 148 is executed.

In operation 730, the processor 120 may move to a page of providing product information based on a user input.

In operations 740 and 750, if there is information about a targeted product, the processor 120 may provide the information about the product. The processor 120 may verify whether there is a product ascertained that the user intends to purchase the product currently and may display the product.

In operation 760, if there is no targeted product information, the processor 120 may display information about a product recommended to the user.

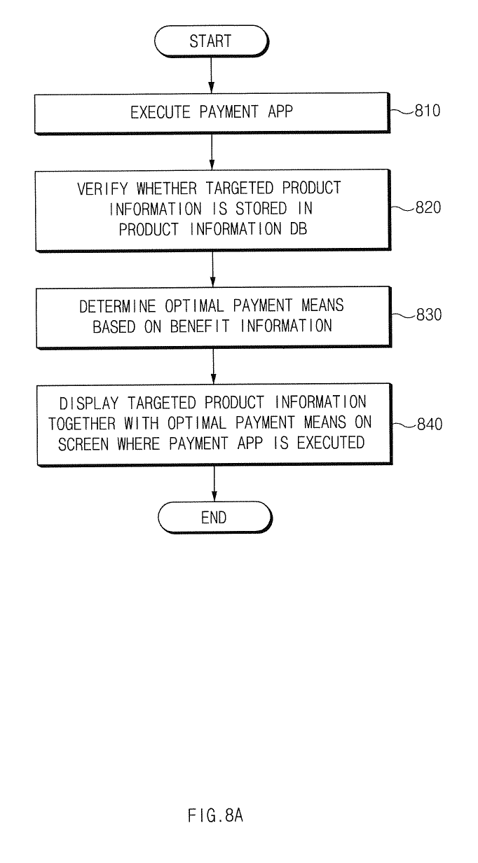

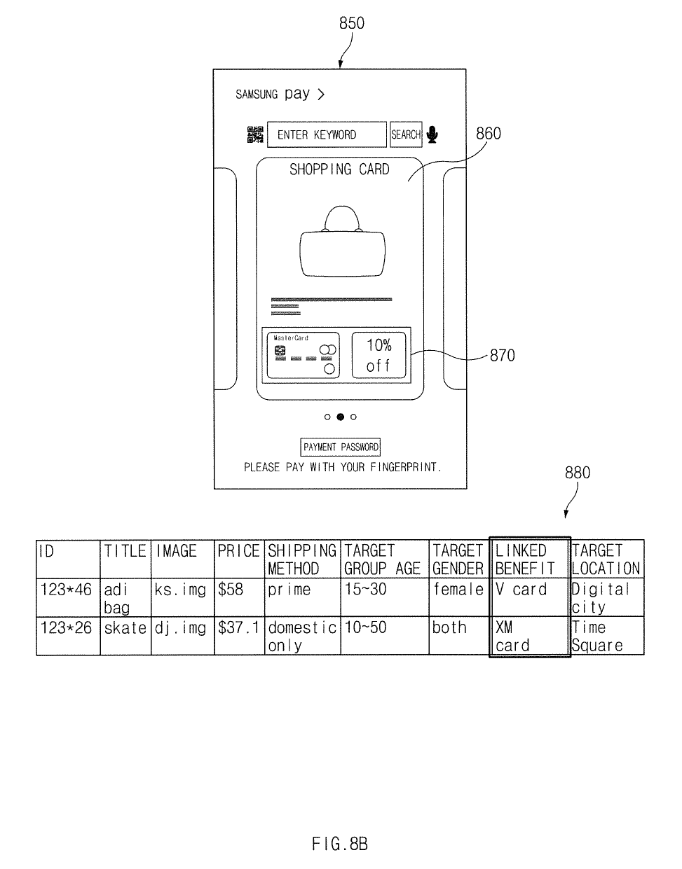

FIG. 8A is a flowchart illustrating a process of providing an optimal payment means together with product information according to various embodiments.

Referring to FIG. 8A, in operation 810, a processor 120 of FIG. 1 may execute a payment app 148 of FIG. 1. The payment app 148 may be executed by a user input (e.g., execution of an icon, a fingerprint input, or the like) or may be automatically executed (e.g., a call of another app or the like).

In operation 820, the processor 120 may verify whether targeted product information associated with a user of an electronic device 101 of FIG. 1 is stored in a product information DB 135 of FIG. 1.

In operation 830, the processor 120 may determine an optimal payment means based on benefit information included in the targeted product information. Product information stored in the product information DB 135 may include benefit information (e.g., credit card discount information, coupon information, and free gift information) applied to each product. For example, if the user pays for product A using credit card V and if there is the highest discount rate compared with another card, the processor 120 may determine the credit card V as an optimal payment means.

In operation 840, the processor 120 may display the targeted product information together with information about the optimal payment means on at least part of a screen where the payment app 148 is executed.

FIG. 8B is a drawing illustrating an example of a screen which displays an optimal payment means and an example of stored product information according to various embodiments.

Referring to FIG. 8B, on a payment app screen 850, a processor 120 of FIG. 1 may output targeted product information 860 together with information 870 about an optimal payment means. A user of an electronic device 101 of FIG. 1 may simultaneously verify information about a product he or she wants to purchase and optimal discount information on one screen using one operation of executing a payment app 148 of FIG. 1. The user may provide a simple input (e.g., a fingerprint input or a password input) on the payment app screen 850 and may pay a discounted price for a desired product.

Product information 880 may be stored in a product information DB 135 of FIG. 1 and may include a product identifier for each product, a product type, a product image, a product price, an age group of a target customer, a target gender, benefit information, store information, and the like. For example, the benefit information may include credit card discount information, coupon information, free gift information, and the like and may be changed based on a specified condition (e.g., upon booting, upon execution of the payment app 148, or upon reception of a wireless signal) or over a specified time period. Information about a product in which the user has the greatest interest currently and information about a credit card with the highest discount rate may be continuously updated to the product information DB 135.

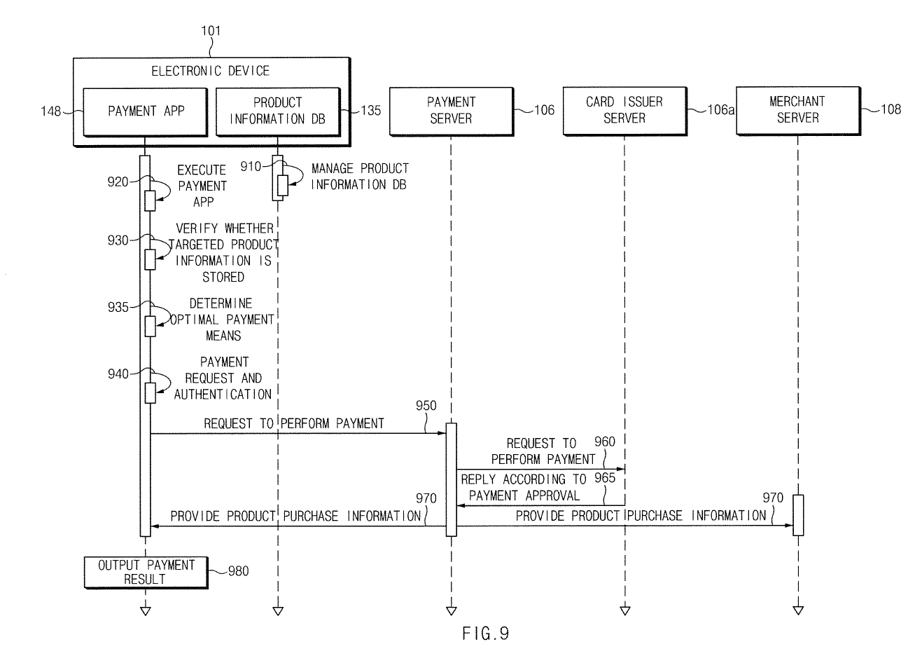

FIG. 9 is a signal sequence diagram illustrating a product payment process through a payment app according to various embodiments. FIG. 9 is, but is not limited to, an example.

In operation 910, a product information DB 135 may continuously manage product information associated with a user of an electronic device 101. The product information may include a product identifier, a product type, a product image, a product price, an age group of a target customer, a target gender, benefit information, store information, and the like.

In various embodiments, a product determined as having a high probability that the user will purchase the product (e.g., a product determined that the number of times of being exposed to advertisements is increased or that a time when being exposed to advertisements is increased, a product determined that the number of times of being searched for is increased, and the like) may have a higher priority order. A product determined as having a low probability that the user will purchase the product (e.g., a product determined that the number of times of being exposed to advertisements is decreased or that a time when being exposed to advertisements is decreased, a product determined that the number of times of being searched for is decreased, and the like) may have a lower priority order.

According to various embodiments, priority orders of stored products may be managed through numeric values. For example, as priority orders of stored products may be managed through numeric values, products having a priority order of a specific value or less may be deleted from the product information DB 135.

According to various embodiments, the stored products may be managed over time. For example, each of the stored products may include effective time information. A product stored in connection with a home shopping program may be stored to be valid while the program is broadcast. After the program is ended, the product may be deleted from the product information DB 135.

In operation 920, a payment app 148 may be executed by a user input or a call of another app.

In operation 930, the payment app 148 may verify whether information about targeted product is stored in the product information DB 135. The information about the targeted product may be information about a product in which the user has interest or a product with a high probability the user will purchase the product. If the information about the targeted product is stored, the information about the product (e.g., a product image, a product price, and the like) may be displayed on at least part of a screen where the payment app 148 is executed. The user may verify information about a product to be purchased together using an operation of executing the payment app 148.

According to various embodiments, in operation 935, if the targeted product information is stored, the processor 120 may determine an optimal payment means based on benefit information associated with the targeted product information. The benefit information may include credit card discount information, coupon information, free gift information, and the like. Information about the optimal payment means may be displayed together with the targeted product information.

In operation 940, the payment app 148 may receive a payment request (e.g., a fingerprint input or a password input) of the user and may proceed with an authentication process (e.g., proceed with verifying fingerprint validity or password validity).

According to an embodiment, the payment app 148 may receive information (e.g., product destination information and the like) used for payment using account information of the user, previously stored in a payment server 106. According to another embodiment, the payment app 148 may receive information used for payment using account information of the user, previously stored in a merchant server 108 of a merchant who purchases a product to be purchased. According to another embodiment, the payment app 148 may collect information used for payment through a user input.

In operation 950, the payment app 148 may request the payment server 106 to pay for the product using a specific payment mode (e.g., a selected credit card).

In operations 960 and 965, the payment server 106 may request a card issuer server 106a to pay for the product and may receive a reply according to payment approval from the card issuer server 106a.

In operation 970, the payment server 106 may transmit the result of purchasing the product to the payment app 148 of the electronic device 101 and a merchant server 108.

In operation 980, the payment app 148 may output a payment result on a screen of the electronic device 101.

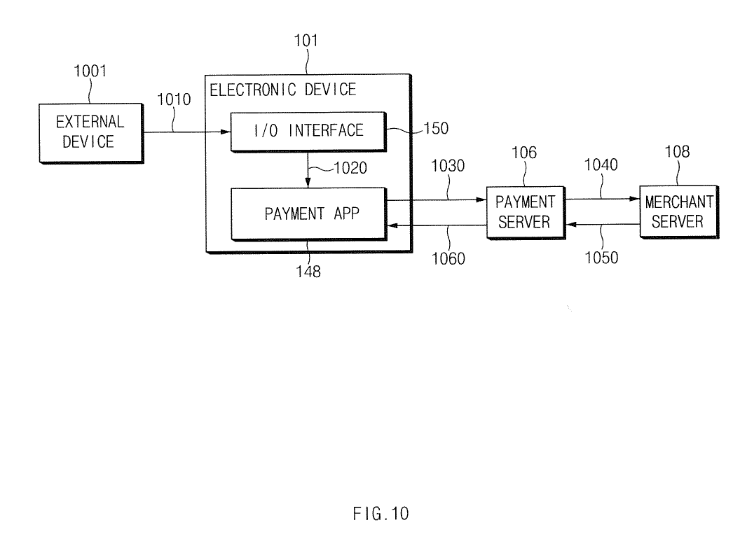

FIG. 10 is a block diagram illustrating a process if product information is not stored in an electronic device according to various embodiments.

Referring to FIG. 10, in operation 1010, if a storage event for storing product information occurs (e.g., if a user enters a product code, if a wireless communication signal is received, or if a sound or image is input), an I/O interface (e.g., a microphone, a communication module, or the like) may receive the storage event.

In operation 1020, a processor 120 of FIG. 1 may parse information about the storage event and may extract a product identifier (e.g., a product code, a product title, or the like) from the parsed information. The extracted product identifier may be provided to a payment app 148. In various embodiments, the operation of parsing the information about the storage event may be performed by the I/O interface 150 or via a separate module.

In operation 1030, if information about a product is not stored in a product information DB 135 of FIG. 1, the payment app 148 may request a payment server 106 to transmit product information.

In operation 1040, if the payment server 106 does not store the information about the product, it may request a merchant server 108 to transmit the information. According to various embodiments, if there are a plurality of merchant servers, the payment server 106 may request the merchant server selected based on a specified condition to transmit information about the product. For example, if the payment server 106 previously stores a merchant identifier about a product, it may request a server of a merchant to transmit product information. For another example, if information about a category of the product is previously stored, the payment server 106 may request a server of a merchant which sells a product of the category to transmit product information.

In operation 1050, the payment server 106 may receive product information from the merchant server 108. In operation 1060, the payment server 106 may provide product information stored in a product information DB 107 of FIG. 1 or product information provided from the merchant server 108 to the payment app 148. The payment app 148 may output the received product information on a screen where the payment app 148 is executed or may store and manage the received product information in the product information DB 135.

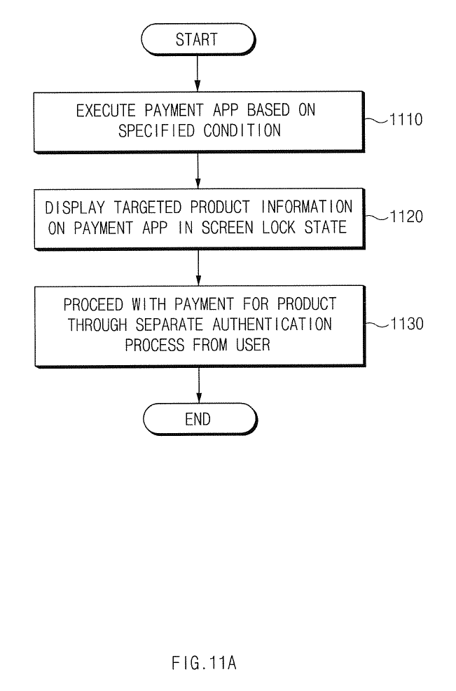

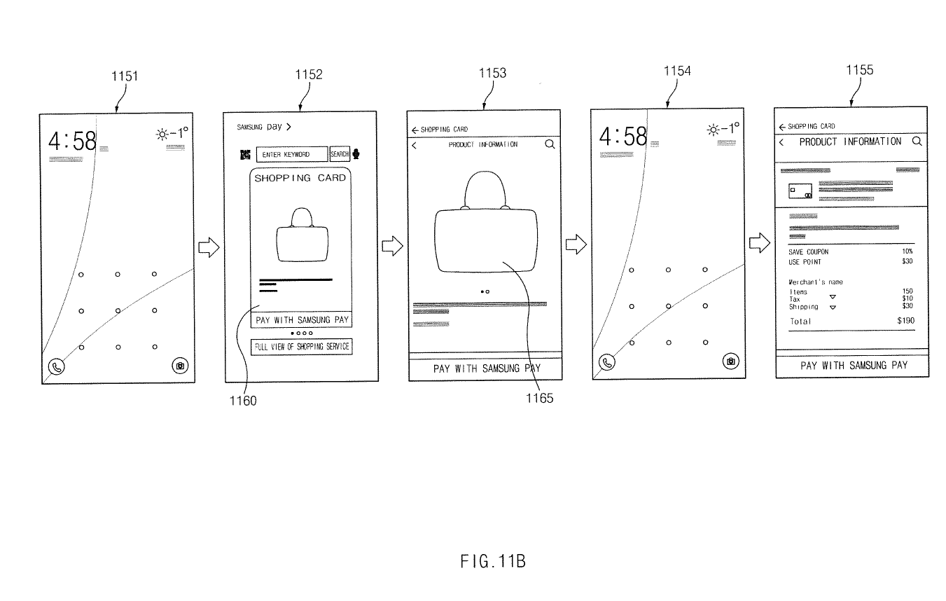

FIG. 11A is a flowchart illustrating a payment mode on a lock screen according to various embodiments.

Referring to FIG. HA, in operation 1110, a processor 120 of FIG. 1 may execute a payment app 148 of FIG. 1 based on a specific condition in a screen lock state. The specified condition may be if product information is received from an external device, if a user of an electronic device 101 of FIG. 1 executes a button for executing the payment app 148, if a specified user input (e.g., a fingerprint input, a biometric information input, or the like) occurs, or the like.

In operation 1120, the processor 120 may execute the payment app 148 in the screen lock state and may display targeted product information on at least part of a screen where the payment app 148 is executed. For example, if a user authentication method (e.g., a fingerprint input) for unlocking a lock screen is the same as a user authentication method (e.g., a fingerprint input) for performing payment, the payment app 148 may be executed. For another example, if a user authentication method for unlocking a lock screen is different from a user authentication method for performing payment, the payment app 148 may be executed through a separate user authentication process. The user may verify information about a product he or she wants to purchase in a state where the lock screen is not unlocked.

In operation 1130, the processor 120 may proceed with payment for a product through a separate authentication process (e.g., a fingerprint input, a password input, or the like) from the user. The user may verify information about the product he or she wants to purchase and may proceed with the payment, in the screen lock state.

FIG. 11B is a drawing illustrating an example of product payment in a lock screen state according to various embodiments.

Referring to FIG. 11B, on a screen 1151, an electronic device 101 of FIG. 1 may be in a lock state. A lock screen may be unlocked through a specified user input (e.g., a pattern input, a fingerprint input, a password input, or the like).

On a screen 1152, a processor 120 of FIG. 1 may execute a payment app 148 of FIG. 1 based on a specified condition. If product information is received through a wireless communication signal (e.g., a BLE signal, a beacon signal, or the like) from an external device, the payment app 148 may be executed. Targeted product information 1160 may be displayed on at least part of a screen where the payment app 148 is executed.

According to various embodiments, on a screen 1153, the processor 120 may output an option selection screen 1165 for a product. The option selection screen 1165 may be displayed, if a user of the electronic device 101 touches the targeted product information 1160 or if a user input (e.g., a fingerprint input or a password input) for proceeding with payment is generated.

On a screen 1154, the processor 120 may proceed with payment for the product through a separate authentication process (e.g., a fingerprint input, a password input, or the like) and may output the payment result.

On a screen 1155, if the product purchase procedure is completed, the processor 120 may return to a screen lock state again. The user may verify information about a desired product and may proceed with payment, in a state where a lock screen is not unlocked.

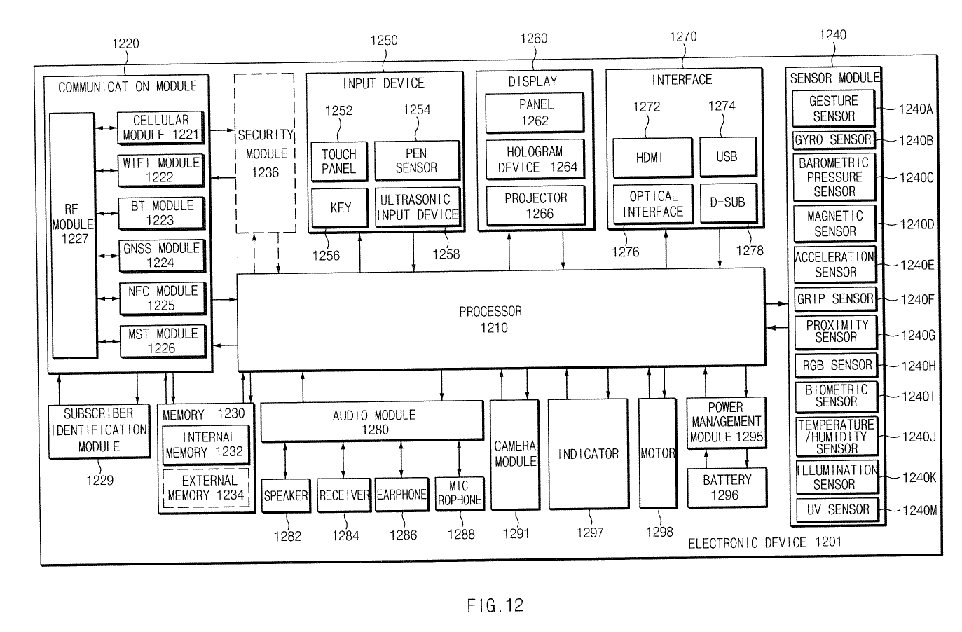

FIG. 12 is a block diagram illustrating a configuration of an electronic device according to an embodiment of the present disclosure.

Referring to FIG. 12, the electronic device 1201 may include, for example, all or part of an electronic device 101 shown in FIG. 1. The electronic device 1201 may include one or more processors 1210 (e.g., application processors (APs)), a communication module 1220, a subscriber identification module (SIM) 1229, a memory 1230, a security module 1236, a sensor module 1240, an input device 1250, a display 1260, an interface 1270, an audio module 1280, a camera module 1291, a power management module 1295, a battery 1296, an indicator 1297, and a motor 1298.

The processor 1210 may drive, for example, an operating system (OS) or an application program to control a plurality of hardware or software components connected thereto and may process and compute a variety of data. The processor 1210 may be implemented with, for example, a system on chip (SoC). According to an embodiment of the present disclosure, the processor 1210 may include a graphic processing unit (GPU) (not shown) and/or an image signal processor (not shown). The processor 1210 may include at least some (e.g., a cellular module 1221) of the components shown in FIG. 12. The processor 1210 may load a command or data received from at least one of other components (e.g., a non-volatile memory) into a volatile memory to process the data and may store various data in a non-volatile memory.

The communication module 1220 may have the same or similar configuration to the communication interface 170 of FIG. 1. The communication module 1220 may include, for example, the cellular module 1221, a wireless-fidelity (Wi-Fi) module 1222, a Bluetooth (BT) module 1223, a global navigation satellite system (GNSS) module 1224 (e.g., a GPS module, a Glonass module, a Beidou module, or a Galileo module), a near field communication (NFC) module 1225, an MST module 1226, and a radio frequency (RF) module 1227.

The cellular module 1221 may provide, for example, a voice call service, a video call service, a text message service, or an Internet service, and the like through a communication network. According to an embodiment of the present disclosure, the cellular module 1221 may identify and authenticate the electronic device 1201 in a communication network using the SIM 1229 (e.g., a SIM card). According to an embodiment of the present disclosure, the cellular module 1221 may perform at least part of functions which may be provided by the processor 1210. According to an embodiment of the present disclosure, the cellular module 1221 may include a communication processor (CP).

The Wi-Fi module 1222, the BT module 1223, the GNSS module 1224, the NFC module 1225, or the MST module 1226 may include, for example, a processor for processing data transmitted and received through the corresponding module. According to various embodiments of the present disclosure, at least some (e.g., two or more) of the cellular module 1221, the Wi-Fi module 1222, the BT module 1223, the GNSS module 1224, the NFC module 1225, or the MST module 1226 may be included in one integrated chip (IC) or one IC package.

The RF module 1227 may transmit and receive, for example, a communication signal (e.g., an RF signal). Though not shown, the RF module 1227 may include, for example, a transceiver, a power amplifier module (PAM), a frequency filter, or a low noise amplifier (LNA), or an antenna, and the like. According to another embodiment of the present disclosure, at least one of the cellular module 1221, the Wi-Fi module 1222, the BT module 1223, the GNSS module 1224, the NFC module 1225, or the MST module 1226 may transmit and receive an RF signal through a separate RF module.

The SIM 1229 may include, for example, a card which includes a SIM and/or an embedded SIM. The SIM 1229 may include unique identification information (e.g., an integrated circuit card identifier (ICCID)) or subscriber information (e.g., an international mobile subscriber identity (IMSI)).

The memory 1230 (e.g., a memory 130 of FIG. 1) may include, for example, an embedded memory 1232 or an external memory 1234. The embedded memory 1232 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1234 may include a flash drive, for example, a compact flash (CF), a secure digital (SD), a micro-SD, a mini-SD, an extreme digital (xD), a multimedia car (MMC), or a memory stick, and the like. The external memory 1234 may operatively and/or physically connect with the electronic device 1201 through various interfaces.

The security module 1236 may be a module which has a relatively higher secure level than the memory 1230 and may be a circuit which stores secure data and provides a protected execution environment. The security module 1236 may be implemented with a separate circuit and may include a separate processor. The security module 1236 may include, for example, an embedded secure element (eSE) which is present in a removable smart chip or a removable SD card or is embedded in a fixed chip of the electronic device 1201. Also, the security module 1236 may be driven by an OS different from the OS of the electronic device 1201. For example, the security module 1236 may operate based on a java card open platform (JCOP) OS.

The sensor module 1240 may measure, for example, a physical quantity or may detect an operation state of the electronic device 1201, and may convert the measured or detected information to an electric signal. The sensor module 1240 may include at least one of, for example, a gesture sensor 1240A, a gyro sensor 1240B, a barometric pressure sensor 1240C, a magnetic sensor 1240D, an acceleration sensor 1240E, a grip sensor 1240F, a proximity sensor 1240G, a color sensor 1240H (e.g., red, green, blue (RGB) sensor), a biometric sensor 1240I, a temperature/humidity sensor 1240J, an illumination sensor 1240K, or an ultraviolet (UV) sensor 1240M. Additionally or alternatively, the sensor module 1240 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 1240 may further include a control circuit for controlling at least one or more sensors included therein. According to various embodiments of the present disclosure, the electronic device 1201 may further include a processor configured to control the sensor module 1240, as part of the processor 1210 or to be independent of the processor 1210. While the processor 1210 is in a sleep state, the electronic device 1201 may control the sensor module 1240.

The input device 1250 may include, for example, a touch panel 1252, a (digital) pen sensor 1254, a key 1256, or an ultrasonic input device 1258. The touch panel 1252 may use at least one of, for example, a capacitive type, a resistive type, an infrared type, or an ultrasonic type. Also, the touch panel 1252 may further include a control circuit. The touch panel 1252 may further include a tactile layer and may provide a tactile reaction to a user.

The (digital) pen sensor 1254 may be, for example, part of the touch panel 1252 or may include a separate sheet for recognition. The key 1256 may include, for example, a physical button, an optical key, or a keypad. The ultrasonic input device 1258 may allow the electronic device 1201 to detect a sound wave using a microphone (e.g., a microphone 1288) and to verify data through an input tool generating an ultrasonic signal.

The display 1260 (e.g., a display 160 of FIG. 1) may include a panel 1262, a hologram device 1264, or a projector 1266. The panel 1262 may include the same or similar configuration to the display 160. The panel 1262 may be implemented to be, for example, flexible, transparent, or wearable. The panel 1262 and the touch panel 1252 may be integrated into one module. The hologram device 1264 may show a stereoscopic image in a space using interference of light. The projector 1266 may project light onto a screen to display an image. The screen may be positioned, for example, inside or outside the electronic device 1201. According to an embodiment of the present disclosure, the display 1260 may further include a control circuit for controlling the panel 1262, the hologram device 1264, or the projector 1266.

The interface 1270 may include, for example, a high-definition multimedia interface (HDMI) 1272, a universal serial bus (USB) 1274, an optical interface 1276, or a D-subminiature 1278. The interface 1270 may be included in, for example, the communication interface 170 shown in FIG. 1. Additionally or alternatively, the interface 1270 may include, for example, a mobile high definition link (MHL) interface, an SD card/multimedia card (MMC) interface, or an infrared data association (IrDA) standard interface.

The audio module 1280 may convert a sound and an electric signal in dual directions. At least part of components of the audio module 1280 may be included in, for example, an input and output interface 150 (or a user interface) shown in FIG. 1. The audio module 1280 may process sound information input or output through, for example, a speaker 1282, a receiver 1284, an earphone 1286, or the microphone 1288, and the like.

The camera module 1291 may be a device which captures a still image and a moving image. According to an embodiment of the present disclosure, the camera module 1291 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1295 may manage, for example, power of the electronic device 1201. According to an embodiment of the present disclosure, though not shown, the power management module 1295 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1296 and voltage, current, or temperature thereof while the battery 1296 is charged. The battery 1296 may include, for example, a rechargeable battery or a solar battery.

The indicator 1297 may display a specific state of the electronic device 1201 or part (e.g., the processor 1210) thereof, for example, a booting state, a message state, or a charging state, and the like. The motor 1298 may convert an electric signal into mechanical vibration and may generate vibration or a haptic effect, and the like. Though not shown, the electronic device 1201 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a MediaFLO™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

According to various embodiments, an electronic device includes a memory, a display and a processor configured to electrically connect with the memory and the display, wherein the processor is configured to execute a payment application program for performing payment about a product, if receiving a first user input, display a user interface for searching for the product on at least part of a screen where the payment app is executed, collect a product identifier based on a second user input, if receiving the second user input on the user interface, display information about the product based on the product identifier, perform user authentication for the payment for the product, and request an external payment server to perform the payment and receive the payment result corresponding to the request.

According to various embodiments, the processor is configured to display information about a payment means of the product and the user interface on one screen.

According to various embodiments, the first user input comprises at least one of a touch input, a swipe input, a force touch input, a multi-touch input, or a gesture input.

According to various embodiments, the processor is configured to execute the payment app, if receiving the first user input in at least one of a screen-off state, a lock screen output state, and a home screen output state.

According to various embodiments, the processor is configured to provide the user interface for receiving at least one of a text input, an input using a camera of the electronic device, or an input using a microphone of the electronic device.

According to various embodiments, the second user input comprises at least one of a text code input, a barcode input, a quick response (QR) code input, or a sound input.

According to various embodiments, the processor is configured to request the payment server to transmit the information about the product based on the product identifier.

According to various embodiments, the processor is configured to receive account information of a user, previously stored in the payment server or a server of a merchant who sells the product.

According to various embodiments, an electronic device includes a memory, a display and a processor configured to electrically connect with the memory and the display, wherein the processor is configured to collect a product identifier based on at least one of movement information of the electronic device or a wireless communication signal received from an external device, receive and store information about a product from an external payment server based on the collected product identifier, execute a payment app for performing payment about the product, if receiving a first user input, display information about a payment means of the product and the stored information about the product, perform user authentication for the payment for the product, and request the payment server to perform the payment and receive the payment result corresponding to the request.

According to various embodiments, the processor is configured to display the information about the product on part of a screen where the payment app is loaded or part of an initial screen where the payment app is executed.

According to various embodiments, the processor is configured to display the information about the product to occupy an area or more of a screen where the payment app is executed.

According to various embodiments, the processor is configured to display the information about the product to occupy less than an area of a screen where the payment app is executed.

According to various embodiments, the processor is configured to display product information recommended to a user of the electronic device on at least part of a screen where the payment app is executed, if the information about the product is not stored in the memory.

According to various embodiments, the processor is configured to display information about an optimal payment means on at least part of a screen where the payment app is executed, based on benefit information included in the information about the product.

According to various embodiments, if there are a plurality of products, the processor is configured to display a list of the plurality of products on at least part of a screen where the payment app is executed.

According to various embodiments, an electronic device includes a housing configured to include a first surface and a second surface which faces a direction opposite to the first surface, a touch screen display configured to be exposed through at least part of the first surface and include a screen having a first edge which is extended in a first direction and has a first length, a second edge which is extended in a second direction perpendicular to the first direction and has a second length which is shorter than the first length, a third edge which has the first length and is parallel to the first edge, and a fourth edge which has the second length and is parallel to the second edge, a wireless communication circuit configured to be included in the housing, at least one input circuit configured to obtain an image and/or a sound, a processor configured to be included in the housing and electrically connect with the touch screen display and the wireless communication circuit and a memory configured to be included in the housing and electrically connect with the processor, wherein the memory stores a payment application program including a user interface, and wherein the memory includes instructions, when executed, causing the processor to receive a gesture input started from one of the first to fourth edges, on the touch screen display, display the user interface including payment card information to be used for transaction through the payment application program on the touch screen display in response to the gesture input, receive an input about a target of the transaction using the user interface and/or the at least one input circuit, transmit information based on the input to an external server using the wireless communication circuit, receive a response based on the information using the wireless communication circuit, display information about the target of the transaction on the touch screen display based on the response, receive authentication information for the transaction, transmit payment information associated with the target of the transaction via the wireless communication circuit in response to receiving the authentication information and receive a response associated with the transaction via the wireless communication circuit.

According to various embodiments, the electronic device further includes a biometric authentication circuit, and the instructions, when executed, causing the processor to, receive the authentication information using the biometric authentication circuit.

According to various embodiments, the instructions, when executed, causing the processor to receive a symbol, text, and/or numeric input associated with the target of the transaction via the user interface.

According to various embodiments, the at least one input circuit comprises an image acquisition circuit, and the instructions, when executed, causing the processor to obtain an image associated with the target of the transaction using the image acquisition circuit.

According to various embodiments, the at least one input circuit comprises a sound acquisition circuit, and the instructions, when executed, causing the processor to obtain a sound associated with the target of the payment using the sound acquisition circuit.

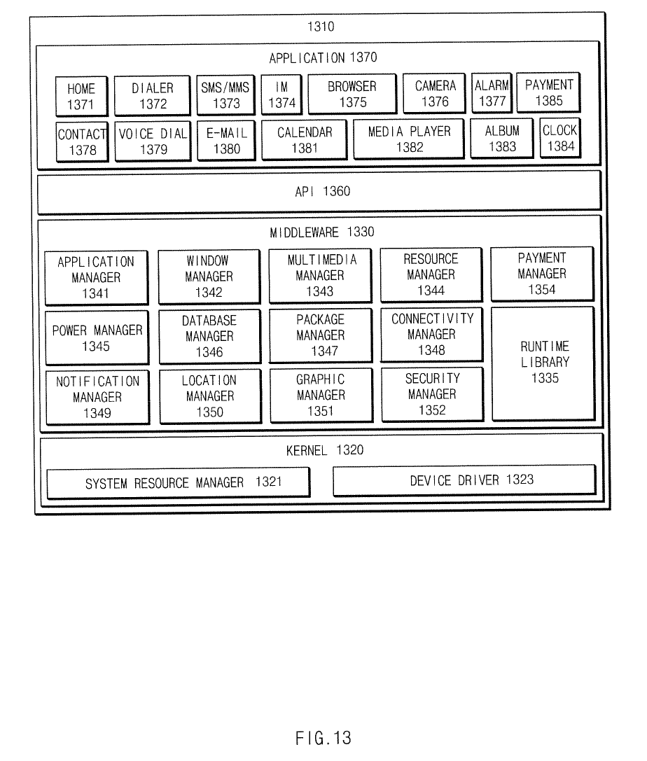

FIG. 13 is a block diagram illustrating a configuration of a program module 1310 according to an embodiment of the present disclosure.

According to an embodiment of the present disclosure, the program module 1310 (e.g., a program 140 of FIG. 1) may include an operating system (OS) for controlling resources associated with an electronic device (e.g., an electronic device 101 of FIG. 1) and/or various applications (e.g., an application program 147 of FIG. 1) which are executed on the OS. The OS may be, for example, Android, iOS, Windows, Symbian, Tizen, or Bada, and the like.

The program module 1310 may include a kernel 1320, a middleware 1330, an application programming interface (API) 1360, and/or an application 1370. At least part of the program module 1310 may be preloaded on the electronic device, or may be downloaded from an external electronic device (e.g., a first external electronic device 102, a second external electronic device 104, or a server 106, and the like of FIG. 1).

The kernel 1320 (e.g., a kernel 141 of FIG. 1) may include, for example, a system resource manager 1321 and/or a device driver 1323. The system resource manager 1321 may control, assign, or collect, and the like system resources. According to an embodiment of the present disclosure, the system resource manager 1321 may include a process management unit, a memory management unit, or a file system management unit, and the like. The device driver 1323 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 1330 (e.g., a middleware 143 of FIG. 1) may provide, for example, functions the application 1370 uses in common, and may provide various functions to the application 1370 through the API 1360 such that the application 1370 efficiently uses limited system resources in the electronic device. According to an embodiment of the present disclosure, the middleware 1330 (e.g., the middleware 143) may include at least one of a runtime library 1335, an application manager 1341, a window manager 1342, a multimedia manager 1343, a resource manager 1344, a power manager 1345, a database manager 1346, a package manager 1347, a connectivity manager 1348, a notification manager 1349, a location manager 1350, a graphic manager 1351, a security manager 1352, or a payment manager 1354.

The runtime library 1335 may include, for example, a library module used by a compiler to add a new function through a programming language while the application 1370 is executed. The runtime library 1335 may perform a function about input and output management, memory management, or an arithmetic function.

The application manager 1341 may manage, for example, a life cycle of at least one of the application 1370. The window manager 1342 may manage graphic user interface (GUI) resources used on a screen of the electronic device. The multimedia manager 1343 may determine a format utilized for reproducing various media files and may encode or decode a media file using a codec corresponding to the corresponding format. The resource manager 1344 may manage source codes of at least one of the application 1370, and may manage resources of a memory or a storage space, and the like.

The power manager 1345 may act together with, for example, a basic input/output system (BIOS) and the like, may manage a battery or a power source, and may provide power information utilized for an operation of the electronic device. The database manager 1346 may generate, search, or change a database to be used in at least one of the application 1370. The package manager 1347 may manage installation or update of an application distributed by a type of a package file.

The connectivity manager 1348 may manage, for example, wireless connection such as Wi-Fi connection or BT connection, and the like. The notification manager 1349 may display or notify events, such as an arrival message, an appointment, and proximity notification, by a method which is not disturbed to the user. The location manager 1350 may manage location information of the electronic device. The graphic manager 1351 may manage a graphic effect to be provided to the user or a user interface (UI) related to the graphic effect. The security manager 1352 may provide all security functions utilized for system security or user authentication, and the like. According to an embodiment of the present disclosure, when the electronic device (e.g., an electronic device 101 of FIG. 1) has a phone function, the middleware 1330 may further include a telephony manager (not shown) for managing a voice or video communication function of the electronic device.

The middleware 1330 may include a middleware module which configures combinations of various functions of the above-described components. The middleware 1330 may provide a module which specializes according to kinds of OSs to provide a differentiated function. Also, the middleware 1330 may dynamically delete some of old components or may add new components.

The API 1360 (e.g., an API 145 of FIG. 1) may be, for example, a set of API programming functions, and may be provided with different components according to OSs. For example, in case of Android or iOS, one API set may be provided according to platforms. In case of Tizen, two or more API sets may be provided according to platforms.

The application 1370 (e.g., an application program 147 of FIG. 1) may include one or more of, for example, a home application 1371, a dialer application 1372, a short message service/multimedia message service (SMS/MMS) application 1373, an instant message (IM) application 1374, a browser application 1375, a camera application 1376, an alarm application 1377, a contact application 1378, a voice dial application 1379, an e-mail application 1380, a calendar application 1381, a media player application 1382, an album application 1383, a clock application 1384, a payment application 1385, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 1370 may include an application (hereinafter, for better understanding and ease of description, referred to as “information exchange application”) for exchanging information between the electronic device (e.g., the electronic device 101 of FIG. 1) and an external electronic device (e.g., the first external electronic device 102 or the second external electronic device 104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 102 or the second external electronic device 104). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 102 or the second external electronic device 104) which communicates with the electronic device, an application which operates in the external electronic device, or a service (e.g., a call service or a message service) provided from the external electronic device.

According to an embodiment of the present disclosure, the application 1370 may include an application (e.g., the health card application of a mobile medical device) which is preset according to attributes of the external electronic device (e.g., the first external electronic device 102 or the second external electronic device 104). According to an embodiment of the present disclosure, the application 1370 may include an application received from the external electronic device (e.g., the server 106, the first external electronic device 102, or the second external electronic device 104). According to an embodiment of the present disclosure, the application 1370 may include a preloaded application or a third party application which may be downloaded from a server. Names of the components of the program module 1310 according to various embodiments of the present disclosure may differ according to kinds of OSs.

According to various embodiments of the present disclosure, at least part of the program module 1310 may be implemented with software, firmware, hardware, or at least two or more combinations thereof. At least part of the program module 1310 may be implemented (e.g., executed) by, for example, a processor (e.g., a processor 1210). At least part of the program module 1310 may include, for example, a module, a program, a routine, sets of instructions, or a process, and the like for performing one or more functions.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 120), the processor may perform functions corresponding to the instructions. The computer-readable storage medium may be, for example, the memory 130.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

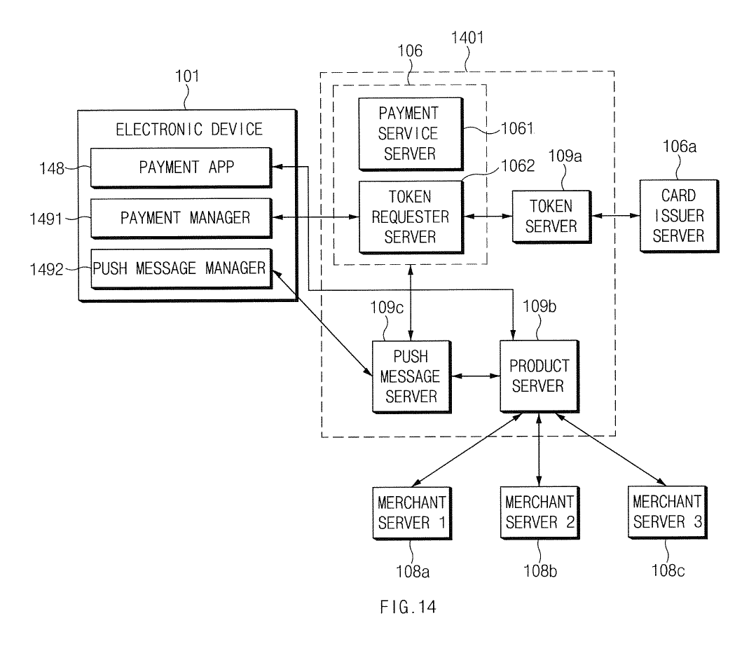

FIG. 14 is a block diagram illustrating a configuration of a payment system according to various embodiments.

Referring to FIG. 14, a payment system 1401 may include an electronic device 101 and/or a server. Also, for example, the server may include a payment server 106, a token server (or a token service provider) 109a, or a card issuer server 106a. The electronic device 101 may include, for example, a payment app (or a wallet app) 148 and/or a payment manager 1491. The payment server 106 may include, for example, a payment service server 1061 and/or a token requester server (or a token requester) 1062.

According to various embodiments, the payment app 148 may include an app associated with product payment (e.g., a Samsung Pay™ app). The payment app 148 may provide, for example, a UI (or a user experience (UX)) associated with payment. The UI (or the UX) associated with the payment may include a wallet UI/UX. For example, the payment app 148 may provide a UI (or a UX) associated with card registration, payment, or transaction. The payment app 148 may provide an interface associated with card registration through a character reader (e.g., an optical character reader/recognition (OCR)) or an external input (e.g., a user input). Also, the payment app 148 may provide, for example, an interface associated with user authentication through identification and verification (ID & V).

According to various embodiments, the payment app 148 may perform payment transaction using the app associated with product payment (e.g., the Samsung Pay™ app). For example, the payment app 148 may provide a payment function to a user of the electronic device 101 through execution of a simply pay, a quick pay, or a specified app. The user may perform a payment function using the payment app 148 or may receive information associated with the payment function.

According to various embodiments, the payment manager 1491 may include information associated with a card issuer. For example, the payment manager 1491 may include a card issuer software development kit (SDK).

According to various embodiments, the payment server 106 may include a management server for electronic payment or mobile payment. The payment server 106 may receive, for example, information associated with payment from the electronic device 101, and may transmit the received information to the outside or may process the received information.

According to various embodiments, the payment server 106 may transmit and receive information between the electronic device 101 and the token server 109a using the payment service server 1061 and/or the token requester server 1062. The payment service server 1061 may include, for example, a payment server (e.g., a Samsung payment server). The payment service server 1061 may manage, for example, card information which interworks with a service account (e.g., a Samsung account) or a user account. Also, the payment service server 1061 may include an application program interface (API) server associated with the payment app 148. Also, the payment service server 1061 may provide, for example, an account management module (e.g., account integration or Samsung account integration).

According to various embodiments, the token requester server 1062 may provide an interface for processing information associated with payment. For example, the token requester server 1062 may issue, delete, or activate information (e.g., a token) associated with payment. Alternatively, the token requester server 1062 may be operatively connected with the payment manager 1491 and may control information used for the payment.

According to various embodiments, the payment app 148 included in the electronic device 101 and the payment service server 1061 included in the payment server 106 may be operatively connected with each other. For example, the payment app 148 may transmit and receive information associated with payment with the payment server 106. According to an embodiment, the payment manager 1491 included in the electronic device 101 and the token requester server 1062 included in the payment server 106 may be operatively connected with each other. For example, the payment manager 1491 may transmit and receive information associated with payment with the token requester server 1062.

According to various embodiments, the token server 109a may issue information (e.g., a token) associated with payment or may manage the information associated with the payment. For example, the token server 109a may control a life cycle of a token. The life cycle may include a generation, correction, or a deletion function. Also, the token server 109a may include, for example, a token management server and may perform token provisioning, ID & V, replenishment, or life cycle management. Also, the token server 109a may perform integration of information associated with the card issuer server 106a.

According to various embodiments, the payment server 106 and/or the token server 109a may be located in the same or similar area or in areas separated from each other. For example, the payment server 106 may be included in a first server, and the token server 109a may be included in a second server. Also, for example, the payment server 106 and/or the token server 109a may be implemented to be divided in one server (e.g., the first server or the second server).

According to various embodiments, the card issuer server 106a may issue a card. For example, the card issuer server 106a may include a card issuer bank. Also, the card issuer server 106a may generate information used for payment, provided to the user. The user may store information used for the payment, generated by the card issuer server 106a, in the electronic device 101 using the payment app 148. Also, the card issuer server 106a may be operatively connected with the token server 109a to transmit and receive information used for the payment with the token server 109a.

A product server 109b may manage a product information DB provided from each of merchant servers 108a to 108c to which the user subscribes. A plurality of information associated with a product may be stored in product information, and a unique identifier may be assigned to the product information.

The merchant servers 108a to 108c may provide product information to a server of a merchant which subscribes to a service and the product server 109b. If product payment is completed, the merchant servers 108a to 108c may provide product information to a user who pays for a product or service.

A push message server 109c may transmit a message for connection maintenance between the payment app 148 and the payment server 106. The push message server 109c may be connected with a push message manager 1492 of the electronic device 101 and may receive a product promotion message and the like from the push message manager 1492.

According to various embodiments of the present disclosure, the product payment method and the electronic device for supporting the same may immediately display information about a product in which the user has interest or a targeted product with a high probability that he or she will purchase the product if he or she starts the payment app and may immediately proceed with payment using the payment app. Therefore, the product payment method and the electronic device for supporting the same may simplify a procedure of purchasing a product using the electronic device such as a smartphone or a tablet PC.

According to various embodiments of the present disclosure, the product payment method and the electronic device for supporting the same may manage a DB for product information in the memory of the electronic device and may quickly provide information, about a product in which the user has interest or a product with a high probability that he or she will purchase the product, to him or her.

According to various embodiments of the present disclosure, the product payment method and the electronic device for supporting the same may simply pay for a product the user wants in the lock screen state.

Although the present disclosure has been described with an example embodiment, various changes and modifications may be suggested to one skilled in the art. It is intended that the present disclosure encompass such changes and modifications as fall within the scope of the appended claims.

What is claimed is:

1. An electronic device, comprising:
a memory;
a display; and
a processor configured to electrically connect with the memory and the display,
wherein the processor is configured to:
execute a payment application program for performing payment for a product, when receiving a first user input;
display a user interface for searching for the product on at least part of a screen where the payment application program is executed;
collect a product identifier based on a second user input, when receiving the second user input on the user interface;
display information about the product based on the product identifier;
perform user authentication for the payment; and
request an external payment server to perform the payment and receive a payment result corresponding to the request.

2. The electronic device of claim 1, wherein the processor is configured to:
display information about a payment means for the payment and the user interface on one screen.

3. The electronic device of claim 1, wherein the first user input comprises at least one of a touch input, a swipe input, a force touch input, a multi-touch input, or a gesture input.

4. The electronic device of claim 1, wherein the processor is configured to:
execute the payment application program, when receiving the first user input in at least one of a screen-off state, a lock screen output state, or a home screen output state.

5. The electronic device of claim 1, wherein the processor is configured to:
provide the user interface for receiving at least one of a text input, an input using a camera of the electronic device, or an input using a microphone of the electronic device.

6. The electronic device of claim 1, wherein the second user input comprises at least one of a text code input, a barcode input, a quick response (QR) code input, or a sound input.

7. The electronic device of claim 1, wherein the processor is configured to:
request the payment server to transmit the information about the product based on the product identifier.

8. The electronic device of claim 1, wherein the processor is configured to:
receive account information of a user, the account information previously stored in the payment server or a server of a merchant who sells the product.

9. An electronic device, comprising:
a memory;
a display; and
a processor configured to electrically connect with the memory and the display,
wherein the processor is configured to:
collect a product identifier based on at least one of movement information of the electronic device or a wireless communication signal received from an external device;
receive and store information about a product from an external payment server based on the collected product identifier;
execute a payment app for performing payment for the product, when receiving a first user input;
display information about a payment means for the payment and the stored information about the product;
perform user authentication for the payment; and
request the payment server to perform the payment and receive a payment result corresponding to the request.

10. The electronic device of claim 9, wherein the processor is configured to:
display the information about the product on part of a screen where the payment app is loaded or part of an initial screen where the payment app is executed.

11. The electronic device of claim 9, wherein the processor is configured to:
display the information about the product to occupy an area of a screen where the payment app is executed.

12. The electronic device of claim 9, wherein the processor is configured to:
display the information about the product to occupy less than an area of a screen where the payment app is executed.

13. The electronic device of claim 9, wherein the processor is configured to:
display product information recommended to a user of the electronic device on at least part of a screen where the payment app is executed, when the information about the product is not stored in the memory.

14. The electronic device of claim 9, wherein the processor is configured to:
display information about an optimal payment means on at least part of a screen where the payment app is executed, based on benefit information included in the information about the product.

15. The electronic device of claim 9, wherein the processor is configured to:
when there are a plurality of products, display a list of the plurality of products on at least part of a screen where the payment app is executed.

16. An electronic device, comprising:
a housing configured to include a first surface and a second surface that faces a direction opposite to the first surface;
a touch screen display including a screen including a first edge that is extended in a first direction and has a first length, a second edge that is extended in a second direction perpendicular to the first direction and has a second length that is shorter than the first length, a third edge that has the first length and is parallel to the first edge, and a fourth edge that has the second length and is parallel to the second edge, the touch screen display configured to be exposed through at least part of the first surface;
a wireless communication circuit included in the housing;
at least one input circuit configured to obtain an image or a sound;
a processor included in the housing and configured to be electrically connect with the touch screen display and the wireless communication circuit; and
a memory included in the housing and configured to be electrically connect with the processor,
wherein the memory stores a payment application program including a user interface, and
wherein the memory includes instructions that, when executed, cause the processor to:
receive, on the touch screen display, a gesture input started from one of the first to fourth edges;
display, on the touch screen display, in response to the gesture input, the user interface including payment card information to be used for transaction through the payment application program;
receive, using the user interface or the at least one input circuit, an input about a target of the transaction;
transmit, using the wireless communication circuit, information based on the input to an external server;
receive, using the wireless communication circuit, a response based on the information;
display, on the touch screen display, based on the response, information about the target of the transaction;
receive authentication information for the transaction;
transmit, using the wireless communication circuit, in response to receiving the authentication information, payment information associated with the target of the transaction; and
receive, using the wireless communication circuit, a response associated with the transaction.

17. The electronic device of claim 16, further comprising:
a biometric authentication circuit, and
wherein the instructions, when executed, cause the processor to:
receive the authentication information using the biometric authentication circuit.

18. The electronic device of claim 16, wherein the instructions, when executed, cause the processor to:
receive a symbol, text, or numeric input associated with the target of the transaction via the user interface.

19. The electronic device of claim 16, wherein the at least one input circuit comprises an image acquisition circuit, and
wherein the instructions, when executed, cause the processor to:
obtain an image associated with the target of the transaction using the image acquisition circuit.

20. The electronic device of claim 16, wherein the at least one input circuit comprises a sound acquisition circuit, and
wherein the instructions, when executed, cause the processor to:
obtain a sound associated with the target of the payment using the sound acquisition circuit.
